(19) United States
(12) Patent Application Publication
(10) Pub. No.: US 2018/0059615 A1
(43) Pub. Date: Mar. 1, 2018

(54) IMAGING CARTRIDGE AND MEMORY CHIP APPLIED TO IMAGING CARTRIDGE

(71) Applicant: ZHUHAI NINESTAR MANAGEMENT CO., LTD., Zhuhai (CN)

(72) Inventor: Shengyu WEI, Zhuhai (CN)

(21) Appl. No.: 15/803,340

(22) Filed: Nov. 3, 2017

Related U.S. Application Data
(63) Continuation of application No. PCT/CN2016/080214, filed on Apr. 26, 2016.

(30) Foreign Application Priority Data
Jun. 4, 2015 (CN) 201510304233.5

(51) Int. Cl. G03G 21/18; H04N 1/00; B41J 2/175; G06K 15/02

(52) U.S. Cl. CPC G03G 21/1878; G06K 15/02; B41J 2/17533; H04N 1/00965

(57) ABSTRACT

The present invention discloses an imaging cartridge and a memory chip applied to the imaging cartridge. The memory chip is detachably installable on an imaging cartridge, and the imaging cartridge is detachably installable in the imaging device. The memory chip includes: an interface unit, electrically connecting the memory chip to the imaging device, and receiving an instruction that is sent from the imaging device; a storage unit, storing information related to the imaging cartridge; a service life determining unit, determining, according to the information that is related to the imaging cartridge and that is stored in the storage unit, whether a service life of the imaging cartridge runs out; and an exception processing unit, performing, when the service life determining unit determines that the service life of the imaging cartridge runs out, exception processing according to the instruction sent by the imaging device.

### BACKGROUND

### Technical Field

The present invention mainly relates to the field of imaging technologies, and in particular, to an imaging cartridge and a memory chip applied to the imaging cartridge.

### Related Art

In the prior art, to monitor a usage status of an imaging cartridge in real time, a memory chip storing information related to the imaging cartridge is usually disposed on the imaging cartridge. Generally, a storage module, an interface unit, and the like are disposed on the memory chip. The memory chip is electrically connected to an imaging device (such as an ink-jet printer or a laser printer) by using the interface unit, so as to establish a data transmission channel. The storage module is configured to store the information related to the imaging cartridge. The information is data such as available usage of imaging materials, the quantity of print pages, or a production date. Moreover, as printing and imaging operations are performed, the imaging device gradually updates variable data in the memory chip. The variable data is information such as the quantity of print pages or the available usage of imaging materials.

The imaging device often determines, by observing whether some variable data in the memory chip has reached a preset threshold, whether a service life of the imaging cartridge is to run out, for example, by observing whether the available usage of the imaging materials reaches a preset threshold. The imaging device mainly estimates the available usage of the imaging materials according to data such as the quantity of jetted ink droplets and the weight of the ink droplets. Therefore, a certain calculation error inevitably exists. Due to existence of the calculation error, when the imaging device prompts that the imaging materials in the imaging cartridge is to run out, the imaging materials in the imaging cartridge may have run out, or a few imaging materials may still exist.

Usually, after the available usage of the imaging materials reaches the preset threshold, the imaging device prompts a user on a screen of the imaging device or on a computer client that “Imaging materials are to run out. Whether to continue to print?” In an actual case corresponding to this case, the imaging materials in the imaging cartridge may have run out, or some remaining imaging materials in the imaging cartridge still exist. In this case, if the user chooses to continue to perform a print operation, when the imaging materials already run out, an empty print phenomenon occurs in the imaging device due to a lack of imaging materials, the imaging device is easily caused to be faulty, and a service life of the imaging device is shortened.

### SUMMARY

A technical problem to be resolved by the present invention is to overcome a disadvantage in the prior art that when available usage of imaging materials reaches a preset threshold, an imaging device may still continue to perform an imaging operation, to easily cause a device failure.

The present invention firstly provides a memory chip applied to an imaging cartridge, being detachably installable on an imaging cartridge, where the imaging cartridge is capable of being detachably installable in an imaging device, and the memory chip includes: an interface unit, configured to electrically connect the memory chip to the imaging device, and receive an instruction that is sent from the imaging device; a storage unit, configured to store information related to the imaging cartridge; a service life determining unit, configured to determine, according to the information that is related to the imaging cartridge and that is stored in the storage unit, whether a service life of the imaging cartridge runs out; and an exception processing unit, configured to: when the service life determining unit determines that the service life of the imaging cartridge runs out, perform exception processing according to the instruction sent by the imaging device.

Preferably, the service life determining unit determines, according to a parameter that directly or indirectly indicates available usage of print materials, whether the service life of the imaging cartridge runs out, where the information related to the imaging cartridge includes the parameter that directly or indirectly indicates available usage of print materials.

Preferably, the service life determining unit determines, according to whether available usage information of the print materials reaches a preset threshold, according to whether usage information of the print materials reaches a preset threshold, or according to whether a flag bit indicating an available usage status of the print materials changes, whether the service life of the imaging cartridge runs out, where the parameter that directly or indirectly indicates available usage of print materials includes the available usage information of the print materials, the usage information of the print materials, or the flag bit indicating an available usage status of the print materials.

Preferably, the exception processing unit is configured to: when the service life determining unit determines that the service life of the imaging cartridge runs out, skip responding to the instruction of the imaging device or incorrectly respond to the instruction of the imaging device, so as to perform the exception processing.

Preferably, the exception processing unit is configured to: when the service life determining unit determines that the service life of the imaging cartridge runs out, according to the instruction sent by the imaging device, erase some or all of data stored in the storage unit, so as to skip responding to the instruction of the imaging device; or change an electrical characteristic of the memory chip, so as to incorrectly respond to the instruction of the imaging device.

Preferably, the memory chip includes: a control unit, configured to stop, according to a response forbidding command sent by the exception processing unit, responding to the instruction of the imaging device, where the exception processing unit is configured to:

when the service life determining unit determines that the service life of the imaging cartridge runs out, send the response forbidding command to the control unit according to the instruction sent by the imaging device.

Preferably, a control unit is configured to send, to the imaging device according to an incorrect response command sent by the exception processing unit, an incorrect response enabling the imaging device consider that the memory chip is exceptional, where the exception processing unit is configured to: when the service life determining unit determines that the service life of the imaging cartridge runs out, send the incorrect response command to the control unit according to the instruction sent by the imaging device.

The present invention further provides an imaging cartridge, where the memory chip described above is detachably installable on the imaging cartridge.

The present invention further provides a method for enabling an imaging device to stop an imaging operation, where an imaging cartridge is detachably installable in the imaging device, a memory chip is detachably installable on the imaging cartridge, and the imaging device is electrically connected to the memory chip; the memory chip performs the following steps in the method: receiving an instruction sent by the imaging device; determining, according to information related to the imaging cartridge, whether a service life of the imaging cartridge runs out; and when it is determined that the service life of the imaging cartridge runs out, performing exception processing according to the instruction sent by the imaging device.

Preferably, the determining, according to information related to the imaging cartridge, whether a service life of the imaging cartridge runs out includes: determining, according to a parameter that directly or indirectly indicates available usage of print materials, whether the service life of the imaging cartridge runs out, where the information related to the imaging cartridge includes the parameter that directly or indirectly indicates available usage of print materials.

Preferably, the determining, according to a parameter that directly or indirectly indicates available usage of print materials, whether the service life of the imaging cartridge runs out includes: determining, according to whether available usage information of the print materials reaches a preset threshold, according to whether usage information of the print materials reaches a preset threshold, or according to whether a flag bit indicating an available usage status of the print materials changes, whether the service life of the imaging cartridge runs out, where the parameter that directly or indirectly indicates available usage of print materials includes the available usage information of the print materials, the usage information of the print materials, or the flag bit indicating an available usage status of the print materials.

Preferably, the performing exception processing according to the instruction sent by the imaging device includes: skipping responding to the instruction of the imaging device or incorrectly responding to the instruction of the imaging device, so as to perform the exception processing.

Preferably, the skipping responding to the instruction of the imaging device includes: erasing some or all of data stored in the storage unit; or stopping responding to the instruction of the imaging device.

Preferably, the incorrectly responding to the instruction of the imaging device includes: sending, to the imaging device, an incorrect response enabling the imaging device to consider that the memory chip is exceptional; or changing an electrical characteristic of the memory chip.

Compared with the prior art, by means of the present invention, occurrence of a phenomenon that when imaging materials in an imaging cartridge may run out, a failure occurs in an imaging device due to an empty print can be effectively avoided.

Other features and advantages of the present invention are described in the subsequent specification, and partially become clear in the specification, or are learned by implementing the technical solutions of the present invention. The objective and other advantages of the present invention can be implemented and learned by using structures and/or procedures that are specially pointed out in the specification, the claims, and the accompanying drawings.

### BRIEF DESCRIPTION OF THE DRAWINGS

The accompanying drawings are used to further understand the technical solutions of the present invention or the prior art, and constitute a part of the specification. The accompanying drawings of the embodiments of the present invention and the embodiments of the present invention are both used to explain the technical solutions of the present invention, but do not constitute a limitation on the technical solutions of the present invention.

FIG. 1 is a schematic structural diagram of a memory chip according to an embodiment of the present invention;

FIG. 2 is another schematic structural diagram of a memory chip according to an embodiment of the present invention; and

FIG. 3 is a schematic flowchart of a method for enabling an imaging device to stop an imaging operation according to an embodiment of the present invention.

### DETAILED DESCRIPTION

Implementation manners of the present invention are described below in detail with reference to the accompanying drawings and the embodiments. Therefore, an implementation process of how to resolve a technical problem by using technical means in the present invention and of achieving corresponding technical effects can be fully understood and can be implemented accordingly. The embodiments of the present invention and features of the embodiments may be combined with each other on the premise that the embodiments of the present invention and the features of the embodiments do not conflict with each other. The formed technical solutions are all fall within the protection scope of the present invention.

In addition, steps shown in flowcharts in the accompanying drawings may be performed in a computer system in which a group of computers can execute instructions. Moreover, even though a logical sequence is shown in the flowcharts, in some cases, the shown or described steps may be performed in a sequence different from the sequence herein.

To avoid a risk of occurrence of an empty print (when imaging materials are insufficient, an imaging cartridge still performs an imaging operation) and a failure when an imaging device is short of imaging materials, preferably, in the present invention, when the imaging materials are insufficient, an imaging operation of the imaging device is forcibly stopped in advance, so as to enable a user to change the imaging cartridge, avoiding occurrence of a failure due to an empty print of the imaging device.

A common imaging device includes an ink-jet recording device and a laser recording device. Correspondingly, a common imaging cartridge is mainly an ink-jet ink cartridge loaded with ink and a toner cartridge loaded with toner. Using only an ink-jet printer and an ink-jet ink cartridge as an example, the technical solutions of the embodiments are described in detail with reference to the accompanying drawings. A person of ordinary skill in the art should understand that solution descriptions in the following embodiments are also applicable to print material container of another type and a corresponding recording device. Similarly, the print material container may also be a corresponding container such as a toning agent box capable of containing materials used for printing.

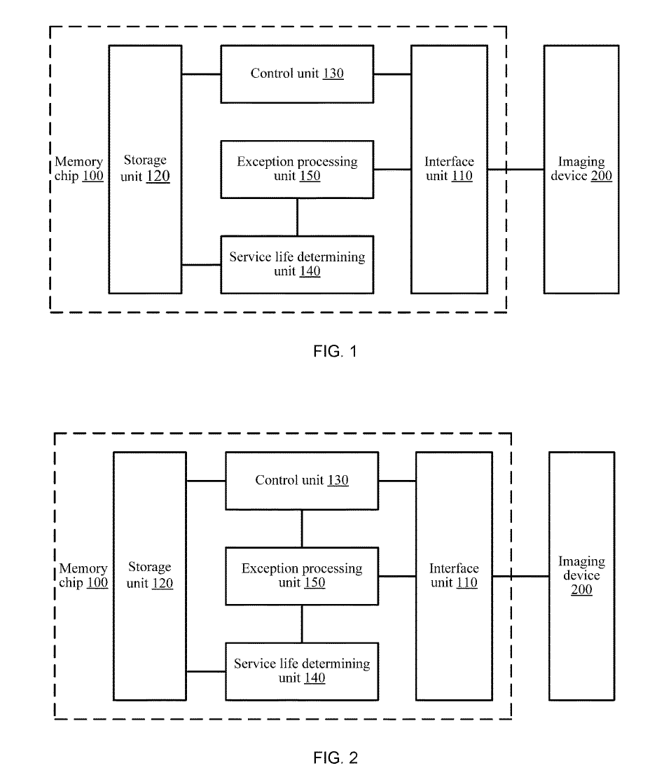

A structure of a memory chip that is capable of being detachably installable on an imaging cartridge and that is provided in an embodiment of the present invention is shown in FIG. 1, and the imaging cartridge (not shown in the figure) is capable of being detachably installable in an imaging device.

In FIG. 1, the memory chip includes: an interface unit 110, a storage unit 120, a control unit 130, a service life determining unit 140, and an exception processing unit 150.

The interface unit 110 is configured to electrically connect the memory chip 100 to the imaging device 200, and receive an instruction that is sent from the imaging device 200. The interface unit 110 may be connected to the imaging device 200 in a wired manner, for example, a contact manner by using a wire or a contact point; or in a wireless manner, for example, a non-contact manner by using Bluetooth, infrared, WiFi, or the like.

The storage unit 120 is configured to store information related to the imaging cartridge. When print materials loaded in the imaging cartridge is ink, the information related to the imaging cartridge may be, for example, ink cartridge identification information, a manufacturer, a production date, an ink amount flag bit, ink usage, and available usage of ink. The ink cartridge identification information may be ink color information, or may be an address of a device of the storage unit 120, or other information that can be used to distinguish different ink cartridge types. The ink amount flag bit is usually used to mark two states of the ink amount, and the two states are being sufficient and being insufficient respectively. The storage unit 120 uses a common non-volatile memory, such as an EPROM, an EEPROM, a FLASH, a ferroelectric memory, or a phase change memory, or may use a solution of using a volatile memory and a power supply, such as an SRAM+a battery or a capacitor, or a DRAM+a battery or a capacitor.

The control unit 130 is connected to the interface unit 110 and the storage unit 120, and is configured to perform a read/write operation on the storage unit 120 in response to the instruction sent by the imaging device 200.

The memory chip 100 in this embodiment further includes a service life determining unit 140 and an exception processing unit 150.

The service life determining unit 140 is connected to the storage unit 120, and is configured to determine, according to information stored in the storage unit 120, whether the service life of the imaging cartridge runs out.

The exception processing unit 150 is connected to the interface unit 110 and the service life determining unit 140, and is configured to: when the service life determining unit 140 determines that the service life of the imaging cartridge runs out, perform exception processing on the memory chip 100 according to the instruction sent by the imaging device 200. Performing exception processing on the memory chip 100 is enabling the memory chip 100 in a normal state to be exceptional, that is, to be in an exceptional state. The memory chip in an exceptional state cannot normally communicate with the imaging device. The imaging device cannot normally communicate with the memory chip, that is, cannot perform a normal operation. Therefore, performing exception processing on the memory chip in a normal state enables the imaging device to stop an imaging operation.

When the service life determining unit 140 determines that the service life of the imaging cartridge does not run out, the control unit 130 performs a read/write operation on the storage unit 120 in response to the instruction sent by the imaging device 200. When the service life determining unit 140 determines that the service life of the imaging cartridge runs out, the control unit 130 may not respond to the instruction sent by the imaging device 200.

The following several manners may be specifically used by the service life determining unit 140 to determine, according to the information stored in the storage unit 120, whether the service life of the imaging cartridge runs out:

In one manner, available usage information of print materials is stored in the storage unit 120, and the service life determining unit 140 determines, according to whether the available usage information of the print materials reaches a preset threshold, whether the service life of the imaging cartridge runs out. For example, the threshold is set to 1% of the amount of full ink of the print materials, and when the available usage information of the print materials indicates that available usage of the print materials is less than or equal to 1% of the amount of the full ink of the print materials, it is determined that the service life of the imaging cartridge runs out. In contrast, if the available usage information of the print materials indicates that the available usage of the print materials is greater than 1% of the amount of the full ink of the print materials, it is determined that the service life of the imaging cartridge does not run out.

In another manner, usage information of print materials is stored in the storage unit 120, and the service life determining unit 140 determines, according to whether the usage information of the print materials reaches a preset threshold, whether the service life of the imaging cartridge runs out. For example, the threshold is set to 99% of the amount of full ink of the print materials, and when the usage information of the print materials indicates that usage of the print materials is greater than or equal to 99% of the amount of the full ink of the print materials, it is determined that the service life of the imaging cartridge runs out. In contrast, if the usage information of the print materials indicates that the usage of the print materials is less than 99% of the amount of the full ink of the print materials, it is determined that the service life of the imaging cartridge does not run out.

In still another manner, a flag bit indicating an available usage status of the print materials is set in the storage unit 120. Initially, that is, when the flag bit has not changed, it indicates that available usage of the print materials is sufficient (does not run out). When the flag bit changes, it indicates that print materials are to run out, and the available usage of the print materials is to be 0. Therefore, the service life determining unit 140 may determine, according to whether the set flat bit changes, whether the service life of the imaging cartridge runs out.

In this embodiment of the present invention, the available usage information of the print materials is used to indicate the number of remaining print materials in the imaging cartridge, and the flag bit is used to indicate the number of remaining print materials in the imaging cartridge. The available usage information and the flag bit can be used as parameters that directly indicate the available usage of the print materials. The number of remaining print materials in the imaging cartridge may also be obtained according to the amount of full ink and the amount of already used ink of the print materials in the imaging cartridge. Therefore, the usage information of the print materials may be used as a parameter that indirectly indicates the available usage of the print materials.

Another parameter that directly or indirectly indicates the available usage of the print materials may also be stored in the memory chip. Similarly, the parameter that directly or indirectly indicates the available usage of the print materials, such as the available usage of the print materials, the usage of the print materials, or the flag bit of an available status of the print materials may be used as a determining object for determining whether the service life of the imaging cartridge runs out. Moreover, the present invention is not merely limited to the available usage of the print materials, the usage of the print materials, or the flag bit of an available status of the print materials that is listed above.

Different exception processing may be performed on the memory chip according to characters of imaging devices. For example, when some imaging devices use whether a response of the memory chip can be received as a standard for determining whether the chip is exceptional, then when the memory chip chooses not to respond to the instruction of the imaging device, the exception processing can be performed. When some imaging devices use whether a received response of the memory chip is correct as a standard for determining whether the chip is exceptional, then when the memory chip returns an incorrect signal (a signal not meeting an expectation) to the imaging device, the exception processing can be performed. Therefore, the exception processing unit 150 may perform exception processing on the memory chip in a manner of “skipping responding to the instruction of the imaging device” or “sending incorrect data to the imaging device in response to the instruction of the imaging device”. Data not conforming with the instruction of the imaging device may all be used as incorrect data in this embodiment of the present invention.

Exception processing is performed on the memory chip, so that the imaging device considers that the memory chip is exceptional and the imaging device is enabled to stop an imaging operation in time. This prevents the imaging device from being damaged due to an empty print of the imaging device caused by the insufficient quantity of print materials.

When this embodiment of the present invention is applied to some occasions, exception processing is performed on the memory chip 100 in no response to the instruction sent by the imaging device. When the service life determining unit 140 determines that the service life of the imaging cartridge runs out, the exception processing unit 150 performs exception processing on the memory chip 100 according to the instruction sent by the imaging device, that is, erases some or all data in the storage unit 120. Data stored in the storage unit 120 generally includes two types. One is application program data. The imaging device does not read and also cannot rewrite the application program data, and the application program data forms a control procedure of the memory chip. The other type is data of the imaging cartridge that is read or rewrite by a printer. The data is, for example, the foregoing information that is related to the imaging cartridge and that includes ink cartridge identification information, a manufacturer, a production date, an ink amount flag bit, and the like.

Therefore, when the exception processing unit 150 erases the application program data, the memory chip 100 cannot perform any given control procedure, so as to skip responding to the instruction of the imaging device. When the exception processing unit 150 erases the data of the imaging cartridge, the memory chip 100 may perform a given control procedure, so as to respond to the instruction of the imaging device, but valid data cannot be read.

When the memory chip uses an application-specific integrated circuit (ASIC), a control function of the memory chip is already built into the circuit. Therefore, in this type of memory chip, the vast majority of or all the data stored in the storage unit 120 is the data of the imaging cartridge. When the memory chip uses a micro controller unit (MCU), the application program data needs to be written into the control function of the memory chip for implementation. Therefore, in this type of memory chip, the data stored in the storage unit 120 is bound to include the two types of data: the application program data and the data of the imaging cartridge. The MCU is a universal controller. Therefore, to implement a function, a proper program needs to be written into the MCU.

Performing exception processing on the memory chip 100 in no response to the instruction sent by the imaging device may also be that the exception processing unit 150 forbids the memory chip 100 to respond to the instruction of the imaging device. The memory chip responds to the instruction of the imaging device by using the control unit 130. Therefore, in this case, the exception processing unit 150 needs to be connected to the control unit 130. As shown in FIG. 2, when the service life determining unit 140 determines that the service life of the imaging cartridge runs out, the exception processing unit 150 forbids, by sending a response forbidding command to the control unit 130, the control unit 130 in the memory chip 100 to respond to the instruction sent by the imaging device. After receiving the response forbidding command sent by the exception processing unit 150, the control unit 130 stops responding to the instruction of the imaging device. Therefore, because the imaging device cannot receive the response of the memory chip 100, the imaging device considers that the memory chip 100 is exceptional, so that the imaging device is enabled to stop an imaging operation in time. This can effectively prevent the imaging device from being damaged due to an empty print of the imaging device caused by the insufficient quantity of print materials.

Responding to the instruction of the imaging device is forbidden. For example, when the imaging device needs to read the available usage information of the print materials of the memory chip 100, the exception processing unit 150 forbids the control unit 130 to return data related to the available usage of the print materials to the imaging device.

In addition, in the standard inter-integrated circuit bus (IIC) protocol, after the imaging device sends a byte of data to the memory chip 100, the memory chip 100 should return a low-level signal, to represent that the data is received (when parity check and cyclic redundancy check (CRC) are conformed with). In this case, the memory chip 100 may not respond to this low-level signal that the memory chip should respond to, so that the imaging device considers that the memory chip 100 is exceptional, and stops an imaging operation in time. In this case, the one byte of data sent by the imaging device to the memory chip 100 is the instruction that is described in the foregoing and that is sent by the memory chip 100. After the memory chip 100 receives the one byte of data, the exception processing unit 150 sends a command of forbidding responding to the low-level signal to the control unit 130, so that the memory chip 100 does not respond to the low-level signal corresponding to the one byte of data. Therefore, because the imaging device cannot receive the low-level signal, the imaging device considers that the memory chip 100 is exceptional and stops an imaging operation.

When this embodiment of the present invention is applied to some occasions, exception processing is performed on the memory chip 100 in a manner of responding to the instruction sent by the imaging device, but returning a signal not meeting an expectation. In response to the instruction of the imaging device, to return an incorrect signal to the imaging device, when the service life determining unit 140 determines that the service life of the imaging cartridge runs out, the exception processing unit 150 of the memory chip 100 performs exception processing on the memory chip 100 in response to the instruction of the imaging device, that is, sends an incorrect response to the imaging device. The incorrect response is beyond a feedback expectation of the instruction sent by the imaging device. Therefore, the imaging device considers that the memory chip 100 is exceptional, and stops an imaging operation in time. This effectively prevents the imaging device from being damaged due to an empty print of the imaging device caused by the insufficient quantity of print materials.

The memory chip 100 responds to the instruction of the imaging device by using the control unit 130. Therefore, in this case, the exception processing unit 150 needs to be connected to the control unit 130. When the service life determining unit 140 determines that the service life of the imaging cartridge runs out, the exception processing unit 150 instructs, by sending an incorrect response command to the control unit 130, the control unit 130 in the memory chip 100 to incorrectly respond to the instruction of the imaging device. Under the action of the control unit 130, the memory chip 100 sends an incorrect response to the imaging device, so that the imaging device considers that the memory chip 100 is exceptional, and the imaging device is enabled to stop an imaging operation in time. This effectively prevents the imaging device from being damaged due to an empty print of the imaging device caused by the insufficient quantity of print materials.

The incorrect response is data that does not meet expectation and that is returned by the memory chip to the imaging device. This data does not match the instruction sent by the imaging device, and does not meet normal answering specifications or content of the memory chip. For example, when the imaging device reads information about a manufacturer of the memory chip, the memory chip deliberately returns incorrect data of the manufacturer to the imaging device, or cannot indicates data of the manufacturer at all. When the imaging device reads identification information of the memory chip, the memory chip deliberately returns identification information that does not exist (that is, incorrect) to the imaging device, or the memory chip cannot indicate data of the identification information at all even though the identification information exists. In addition, a data encryption and verification process often exists between the memory chip and the imaging device. For example, the imaging device instructs, by sending an instruction, the memory chip to perform encryption calculation (usually, an encryption algorithm is set in the memory chip, and the imaging device clearly learns the specific encryption algorithm; after calculation is performed on the memory chip, and data fed back to the imaging device is correct, it indicates that the memory chip is normal). Therefore, the exception processing unit 150 in this embodiment may enable the control unit 130 to deliberately perform encryption calculation by using an incorrect encryption algorithm, or perform encryption calculation by using an incorrect input parameter, so as to return an incorrect response to the imaging device.

In addition, mutation data is also one type of the incorrect response. For example, when the available usage of the print materials already runs out, returning one piece of mutation data such as 100% even 110% or −10% exceeding a normal available usage range to the imaging device also does not meet an expectation of the imaging device.

In some other embodiments of the present invention, in response to the instruction of the imaging device, to return an incorrect signal to the imaging device, when the service life determining unit 140 determines that the service life of the imaging cartridge runs out, the exception processing unit 150 of the memory chip 100 performs exception processing on the memory chip 100 in response to the instruction sent by the imaging device, and changes an electrical characteristic of the memory chip 100.

The memory chip usually communicates with the imaging device by using a fixed electrical characteristic, for example, performs communication at fixed clock frequency. A working voltage, a working current, and the like of the memory chip are all changed within a relatively stable range.

In this embodiment of the present invention, when the service life determining unit 140 determines that the service life of the imaging cartridge runs out, in response to the instruction sent by the imaging device, the exception processing unit 150 changes the electrical characteristic of the memory chip 100, for example, forcibly lowers a clock signal, causing the clock signal to be exceptional. The imaging device considers, according to the clock signal, that the memory chip is exceptional and stops an imaging operation. Alternatively, power consumption of the memory chip is increased, for example, some circuits are short-circuited, so that a current is increased, and the imaging device considers that the memory chip is exceptional and stops an imaging operation. Alternatively, the working voltage of the memory chip is lowered enough so that the imaging device considers that the memory chip is exceptional and stops an imaging operation. In addition to the several listed electrical characteristics, another electrical characteristic of the memory chip may be further changed, as long as the imaging device can learn that the memory chip is exceptional and stop an imaging operation.

In this embodiment of the present invention, when the memory chip needs the imaging device to incorrectly consider that a problem already occurs in the memory chip and the memory chip is already in an exceptional state, two relatively typical implementation methods are provided. In one implementation method, if responding to the instruction of the imaging device is directly skipped, and no response of the memory chip is received within a proper time, the imaging device considers that the memory chip is exceptional and is in an exceptional state. In the other implementation method, incorrect data is returned for the instruction of the imaging device, especially for some relatively key instructions. Certainly, it is also feasible to return the incorrect data for all instructions. If the imaging device receives no correct response of the memory chip within a proper time, the imaging device considers that the memory chip is exceptional and is in an exceptional state. In this way, when the imaging device expects to receive a response but receives no response, or expects to receive an expected response but receives an unexpected response, it is considered that a problem already occurs in the memory chip, and an imaging operation is stopped. This effectively prevents the imaging device from being damaged due to an empty print of the imaging device caused by the insufficient quantity of print materials.

An embodiment of the present invention provides an imaging cartridge including the disclosed memory chip, and the imaging cartridge is detachably installable in an imaging device. For the imaging cartridge in this embodiment of the present invention, refer to the memory chip in the foregoing embodiment of the present invention.

According to the foregoing memory chip, in the method for enabling an imaging device to stop an imaging operation in this embodiment of the present invention, at least one imaging cartridge is detachably installable in the imaging device, the memory chip in the foregoing embodiment is detachably installable on the imaging cartridge, and the memory chip is electrically connected to the memory chip.

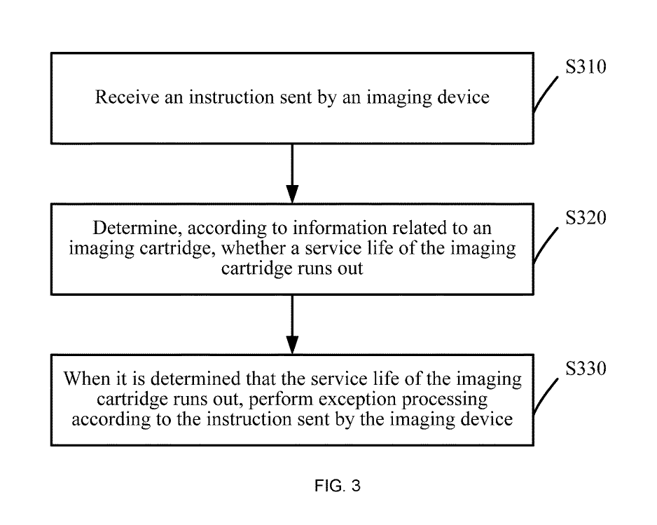

As shown in FIG. 3, the memory chip performs the following steps in the method.

Step S310: Receive an instruction sent by the imaging device.

Step S320: Determine, according to information related to the imaging cartridge, whether a service life of the imaging cartridge runs out.

For example, it may be determined, according to a parameter that directly or indirectly indicates available usage of print materials, whether the service life of the imaging cartridge runs out. The information related to the imaging cartridge includes the parameter that directly or indirectly indicates available usage of print materials.

Determining, according to the parameter that directly or indirectly indicates available usage of print materials, whether the service life of the imaging cartridge runs out may be determining, according to whether available usage information of the print materials reaches a preset threshold, whether the service life of the imaging cartridge runs out, or may be determining, according to usage information of the print materials reaches a preset threshold, whether the service life of the imaging cartridge runs out, or may be determining, according to a flag bit indicating an available usage status of the print materials, whether the service life of the imaging cartridge runs out. The parameter that directly or indirectly indicates available usage of print materials includes the available usage information of the print materials, the usage information of the print materials, or the flag bit indicating the available usage status of the print materials.

Step S330: When it is determined that the service life of the imaging cartridge runs out, perform exception processing according to the instruction sent by the imaging device.

In this embodiment of the present invention, the performing exception processing according to the instruction sent by the imaging device includes: skipping responding to the instruction of the imaging device or incorrectly responding to the instruction of the imaging device. Both of the two manners may be used to perform the exception processing.

Specifically, the skipping responding to the instruction of the imaging device may be erasing some or all of data stored in the storage unit, or may be stopping responding to the instruction of the imaging device.

On the other hand, the incorrectly responding to the instruction of the imaging device may be sending, to the imaging device, an incorrect response enabling the imaging device to consider that the memory chip is exceptional; or changing an electrical characteristic of the memory chip.

The method for enabling an imaging device to stop an imaging operation in this embodiment of the present invention is further understood with reference to the memory chip and the imaging cartridge including the memory chip in the foregoing embodiment of the present invention, and is not described herein again.

A person skilled in the art should understand that composition parts of the device and steps in the method provided in the embodiments of the present invention can be integrated on a single computing apparatus, or distributed on a network including a plurality of computing apparatuses. Optionally, the composition parts and the steps may be implemented by using program code that can be executed by a computing apparatus. Therefore, the composition parts and the steps may be stored in a storage apparatus and executed by the computing apparatus. Alternatively, the composition parts and the steps are respectively made into integrated circuit modules. Alternatively, a plurality of modules or steps thereof is made into a single integrated circuit module for implementation. In this way, the present invention is not limited to any specific combination of hardware and software.

A person of ordinary skill in the art may understand that, all or a part of the steps of the foregoing method embodiments may be implemented by using a program instruction or relevant hardware. The foregoing program may be stored in a computer readable storage medium. When the program runs, the steps of the foregoing method embodiments are performed. The foregoing storage medium may include any medium capable of storing program code, such as a ROM, a RAM, a magnetic disk, or an optical disc.

Even though the implementation manners of the present invention are disclosed in the foregoing, the content is merely implementation manners used to understand the technical solutions of the present invention conveniently, and is not intended to limit the present invention. Any person skilled in the art to which the present invention belongs can make any modification and change to implementation forms and details without departing from the spirit and the scope that are disclosed in the present invention. However, the patent protection scope of the present invention shall still be subject to the scope defined by the appended claims.

1. A memory chip applied to an imaging cartridge, the memory chip being detachably installable on an imaging cartridge, wherein the imaging cartridge is capable of being detachably installable in an imaging device, and the memory chip comprises:
an interface unit, configured to electrically connect the memory chip to the imaging device, and receive an instruction that is sent from the imaging device;
a storage unit, configured to store information related to the imaging cartridge;
a service life determining unit, configured to determine, according to the information that is related to the imaging cartridge and that is stored in the storage unit, whether a service life of the imaging cartridge runs out; and
an exception processing unit, configured to: when the service life determining unit determines that the service life of the imaging cartridge runs out, perform exception processing according to the instruction sent by the imaging device, so that the imaging device considers that the memory chip is exceptional and the imaging device is enabled to stop an imaging operation.

2. The memory chip according to claim 1, wherein:
the exception processing unit is configured to: when the service life determining unit determines that the service life of the imaging cartridge runs out, stop responding to the imaging device or incorrectly responding to the instruction of the imaging device, so as to perform the exception processing.

3. The memory chip according to claim 1, wherein:
the service life determining unit determines, according to a parameter that directly or indirectly indicates available usage of print materials, whether the service life of the imaging cartridge runs out, wherein:
the information related to the imaging cartridge comprises the parameter that directly or indirectly indicates available usage of print materials.

4. The memory chip according to claim 3, wherein:
the service life determining unit determines, according to whether available usage information of the print materials reaches a preset threshold, according to whether usage information of the print materials reaches a preset threshold, or according to whether a flag bit indicating an available usage status of the print materials changes, whether the service life of the imaging cartridge runs out, wherein:
the parameter that directly or indirectly indicates available usage of print materials comprises the available usage information of the print materials, the usage information of the print materials, or the flag bit indicating an available usage status of the print materials.

5. The memory chip according to claim 2, wherein:
the exception processing unit is configured to: when the service life determining unit determines that the service life of the imaging cartridge runs out, according to the instruction sent by the imaging device, change an electrical characteristic of the memory chip, so as to incorrectly respond to the instruction of the imaging device.

6. The memory chip according to claim 2, wherein the memory chip comprises:
a control unit, configured to stop, according to a response forbidding command sent by the exception processing unit, responding to the instruction of the imaging device, wherein:
the exception processing unit is configured to: when the service life determining unit determines that the service life of the imaging cartridge runs out, send the response forbidding command to the control unit according to the instruction sent by the imaging device.

7. The memory chip according to claim 2, wherein:
a control unit, configured to send, to the imaging device according to an incorrect response command sent by the exception processing unit, an incorrect response enabling the imaging device to consider that the memory chip is exceptional, wherein:
the exception processing unit is configured to: when the service life determining unit determines that the service life of the imaging cartridge runs out, send the incorrect response command to the control unit according to the instruction sent by the imaging device.

8. An imaging cartridge, comprising:
a memory chip that is detachably installable, the memory chip comprising:
an interface unit, configured to electrically connect the memory chip to the imaging device, and receive an instruction that is sent from the imaging device;
a storage unit, configured to store information related to the imaging cartridge;
a service life determining unit, configured to determine, according to the information that is related to the imaging cartridge and that is stored in the storage unit, whether a service life of the imaging cartridge runs out; and
an exception processing unit, configured to: when the service life determining unit determines that the service life of the imaging cartridge runs out, perform exception processing according to the instruction sent by the imaging device, so that the imaging device considers that the memory chip is exceptional and the imaging device is enabled to stop an imaging operation.

9. A method for enabling an imaging device to stop an imaging operation, wherein an imaging cartridge is detachably installable in the imaging device, a memory chip is detachably installable on the imaging cartridge, and the imaging device is electrically connected to the memory chip; the memory chip performs the following steps in the method:
receiving an instruction sent by the imaging device;
determining, according to information related to the imaging cartridge, whether a service life of the imaging cartridge runs out; and
when it is determined that the service life of the imaging cartridge runs out, performing exception processing according to the instruction sent by the imaging device, so that the imaging device considers that the memory chip is exceptional and the imaging device is enabled to stop an imaging operation.

10. The method according to claim 9, wherein:
the exception processing is stopping responding to the instruction of the imaging device or incorrectly responding to the instruction of the imaging device.

11. The method according to claim 9, wherein the determining, according to information related to the imaging cartridge, whether a service life of the imaging cartridge runs out comprises:
determining, according to a parameter that directly or indirectly indicates available usage of print materials, whether the service life of the imaging cartridge runs out, wherein:
the information related to the imaging cartridge comprises the parameter that directly or indirectly indicates available usage of print materials.

12. The method according to claim 11, wherein the determining, according to a parameter that directly or indirectly indicates available usage of print materials, whether the service life of the imaging cartridge runs out comprises:
determining, according to whether available usage information of the print materials reaches a preset threshold, according to whether usage information of the print materials reaches a preset threshold, or according to whether a flag bit indicating an available usage status of the print materials changes, whether the service life of the imaging cartridge runs out, wherein:
the parameter that directly or indirectly indicates available usage of print materials comprises the available usage information of the print materials, the usage information of the print materials, or the flag bit indicating an available usage status of the print materials.

13. The method according to claim 10, wherein the incorrectly responding to the instruction of the imaging device comprises:
sending, to the imaging device, an incorrect response enabling the imaging device to consider that the memory chip is exceptional; or
changing an electrical characteristic of the memory chip.

14. The imaging cartridge according to claim 8, wherein:
the exception processing unit is configured to: when the service life determining unit determines that the service life of the imaging cartridge runs out, stop responding to the imaging device or incorrectly responding to the instruction of the imaging device, so as to perform the exception processing.
